(19) United States
(12) Patent Application Publication
(10) Pub. No.: US 2026/0141639 A1
(43) Pub. Date: May 21, 2026

(54) METHOD AND SYSTEM FOR CREATING 3D MODEL FOR DIGITAL TWIN FROM POINT CLOUD

(71) Applicant: Siemens Industry Software Ltd., Tel Aviv (IL)

(72) Inventors: Ahmed Agbaryah, Jish (IL); Rafael Blumenfeld, Raanana (IL)

(21) Appl. No.: 18/706,242

(22) PCT Filed: Dec. 2, 2021
(86) PCT No.: PCT/IB2021/061232

§ 371 Date: Apr. 30, 2024

Related U.S. Application Data
(63) Continuation of application No. PCT/IB2021/060439, filed on Nov. 11, 2021.

(51) Int. Cl. G06T 17/20; G06V 10/42; G06V 10/774

(52) U.S. Cl. CPC G06T 17/20; G06V 10/421; G06V 10/774

(57) ABSTRACT

A system and a method create a CAD model from a point cloud. The method includes acquiring the point cloud representing a scene showing objects. A segmentation algorithm is used and configured for receiving as an input the point cloud, for detecting at least one object in the point cloud, and for outputting, for each object detected in the point cloud, an object type and a list of bounding boxes (hereafter “bbox”). One or several object families are acquired. Each object family contains a profile defined for a point cloud meshing algorithm. The profile is configured for specifying a meshing technique to be used by the point cloud meshing algorithm when converting a point cloud representing an object belonging to the object family to a 3D surface. Each family contains one or several of the predefined object types.

The present application claims the priority of the international patent application PCT/IB 2021/060439 filed Nov. 11, 2021, the disclosure of which is hereby incorporated by reference in its entirety.

### TECHNICAL FIELD

The present disclosure is directed, in general, to computer-aided design, visualization, and manufacturing (“CAD”) systems, product lifecycle management (“PLM”) systems, product data management (“PDM”) systems, production environment simulation, and similar systems, that manage data for products and other items (collectively, “Product Data Management” systems or PDM systems). More specifically, the disclosure is directed to production environment simulation.

### BACKGROUND OF THE DISCLOSURE

In manufacturing plant design, three-dimensional (“3D”) digital models of manufacturing assets are used for a variety of manufacturing planning purposes. Examples of such usages includes, but are not limited by, manufacturing process analysis, manufacturing process simulation, equipment collision checks and virtual commissioning.

As used herein the terms manufacturing assets and devices denote any resource, machinery, part and/or any other object, like machines, present in the manufacturing lines.

Manufacturing process planners use digital solutions to plan, validate and optimize production lines before building or modifying the lines, to minimize errors and shorten commissioning time.

Process planners are typically required during the phase of 3D digital modeling of the assets of the plant lines.

While digitally planning the production processes of manufacturing lines, the manufacturing simulation planners need to insert into the virtual scene a large variety of devices that are part of the production lines. Examples of plant devices include, but are not limited by, industrial robots and their tools, transportation assets like e.g. conveyors, turn tables, safety assets like e.g. fences, gates, automation assets like e.g. clamps, grippers, fixtures that grasp parts and more.

In such a context, the point cloud, i.e. the digital representation of a physical object or environment by a set of data points in space, became more and more relevant for applications in the industrial world. Indeed, the acquisition of point clouds with 3D scanners enables for instance to rapidly get a 3D image of a scene, e.g. of a production line of a shop floor, said 3D image being more correct (in terms of content) and up to date compared to designing the same scene using 3D tools. This ability of the point cloud technology to rapidly provide a current and correct representation of an object of interest is of great interest for decision taking and task planning since it shows the very latest and exact status of the shop floor.

From said point cloud, it is then possible to reconstruct an image, e.g. a 2D or 3D image of said environment or object, using meshing techniques. The latter are configured for creating 3D meshes from the points of the cloud, converting the point cloud to 3D surfaces. Nowadays, meshing tools to automatically create such meshes or even directly a CAD model from the entire point cloud scene are available. Unfortunately, resulting CAD models are inaccurate and of low-quality. Other techniques are based on a manual selection of point clouds and labelling them based on an existing CAD scene for manually creating a corresponding CAD model, or on mapping back CAD models of an existing CAD model library on the point cloud, trying thus to align the points of the point cloud with existing CAD models which do not exactly match the environment or object of the scene. Each of the above-mentioned techniques does not provide satisfactory results, in particular because the considered scene to be meshed is complex and comprises various objects of different types. The resulting meshing is then globally inaccurate enough for further use and needs reworking from the user, which is time-and energy-consuming. Therefore, improved techniques for creating 3D models from point clouds are desirable.

### SUMMARY OF THE DISCLOSURE

Various disclosed embodiments include methods, systems, and computer readable mediums for processing a point cloud representing a scene comprising one or several objects, and automatically creating from said point cloud an accurate CAD model of at least one of said objects. A method includes acquiring or receiving, for instance via a first interface, a point cloud representing a scene, wherein said scene comprises said one or several objects; using a segmentation algorithm (hereafter “SA”) for detecting at least one of said one or several objects (i.e. the “point” representation of at least one of said one or several objects) in said point cloud, the SA being configured for outputting, for each object detected in the point cloud, an object type and a bounding box (hereafter “bbox”) list, wherein the object type belongs to a set of one or several predefined object types that the SA has been trained to identify, and wherein each bbox of the bbox list defines a spatial location within the point cloud that comprises a set of points of said point cloud that represent said object or a part of the latter (i.e. that belongs to said object or said part); receiving or acquiring one or several object families, wherein each object family comprises a profile defined for a point cloud meshing algorithm, wherein said profile is configured for specifying a meshing technique, e.g. meshing parameters, to be used by said point cloud meshing algorithm when converting a point cloud representing an object belonging to said object family to a 3D surface, wherein each family comprises one or several of said predefined object types so that each predefined object type be assigned to a single family, and wherein each family is assigned to a different profile; for each object detected, determining the family to which its object type belongs to, and then automatically creating a CAD model by running the point cloud meshing algorithm on the set(s) of points assigned or associated to the bbox(es) of said bbox list, wherein said running comprises using the meshing technique defined for the profile assigned to the family to which the object type of the detected object belongs to for converting said set(s) of points to 3D surface(s) of the CAD model; automatically providing (206) the created CAD model via a second interface, which can be the same as the first interface. The created CAD model can be automatically stored in a database. Preferentially, the method comprises automatically replacing the set(s) of points assigned or associated to the bbox(es) of said list by the created CAD model. Preferentially, the method comprises also displaying the created CAD model.

The SA is thus configured for receiving as input said point cloud, for identifying within said point cloud one or several of said sets of points (or clusters of points), wherein each set of points defines a volume (i.e. a specific spatial distribution and/or configuration of points) that is identified by the SA as representing an object, or a part of the latter, that belongs to one of the predefined object types, i.e. an object or object part that the SA has been trained to recognize or identify. According to known point cloud techniques, each set of points defines an external surface or boundary of a volume that represents the shape of said object or of said part of the latter. The SA is thus configured for detecting said one or several objects in the point cloud from the spatial distribution and/or configuration of the points of the cloud, identifying thus sets of points whose point spatial configuration and/or distribution (e.g. orientation, location, and size with respect to one or several other sets of points) matches spatial configurations and/or distributions of one of said predefined types of objects it has been trained to identify, wherein each of said identified sets of points is then associated to a bbox describing the spatial location of the concerned set of points within the point cloud. At the end, the SA is configured for outputting, for each object detected, an object type and a bbox list comprising all the bboxes that are each associated to a set of points identified as belonging to (i.e. being part of) the detected object. In particular, the SA might be configured for combining several sets of points (resulting thus in a combination of corresponding bboxes) in order to detect one of said objects and for assigning to the latter said type of object. The bbox is typically configured for surrounding the points of the identified set of points, being usually rectangular with its position defined by the position of its corners when considering each point of the point cloud characterized by a position given with respect to a coordinate system. Preferentially, for each object detected and/or each part of object detected, the SA is further configured for performing said determination of the object family to which said object detected and/or part of object detected belongs to. For this purpose, it might be configured for automatically classifying each object type into an object family, classifying thus each object detected/part of object detected into an object family for which a specific meshing profile has been defined. Compared to existing techniques, this provides the technical advantage of improving the accuracy of the CAD model of objects of a scene that belong to different object families for which a profile has been defined, since the system according to the invention will automatically adapt, in function of the object family and associated profile that have been determined for a concerned object, the most appropriate meshing technique that will be used by the point cloud meshing algorithm for converting the concerned object into a CAD model.

A data processing system comprising a processor and an accessible memory or database is also disclosed, wherein the data processing system is configured to carry out the previously described method.

The present invention proposes also a non-transitory computer-readable medium encoded with executable instructions that, when executed, cause one or more data processing systems to perform the previously described method.

An example of computer-implemented method for providing, by a data processing system, a trained algorithm for detecting at least one object in a point cloud representing a scene and assigning, to each detected object, an object type chosen among a set of one or several predefined types and a list of one or several sets of points and/or a bbox list is also proposed by the present invention. This computer-implemented method comprises:
receiving input training data, wherein the input training data comprise a plurality of point clouds, each representing a scene, preferentially a different scene, each scene comprising one or several objects;
receiving output training data, wherein, for each point cloud received as input, the output training data comprise for, and associate to, at least one, preferentially each, object of the scene, a type of object chosen in said set of one or several predefined types, a list of bboxes, and optionally an object family chosen among in a set of one or several predefined object families, wherein each bbox of the bbox list defines a spatial location within said point cloud comprising a set of points representing (i.e. belonging to) said object or a part of the latter. In other words, said list of bboxes maps a list of one or several sets of points of the point cloud representing said scene to said object or part(s) of the latter, wherein each set of points defines a cluster of points that represents said object or said part of the latter (e.g. an arm of a robot), assigning thus to each of said clusters at least one type of objects (e.g. a cluster representing the arm of the robot might belong to the type “arm” and to the type “robot”). The output training data is thus configured for defining for, or assigning to, each of said sets of points, a bbox configured for describing the spatial location of the concerned set of points with respect to the point cloud (i.e. with respect to a point cloud coordinate system), assigning thus to each object of the scene, an object type and a list of bboxes corresponding to said list of one or several sets of points. Optionally, the output training data associate each object type to an object family, enabling thus to train the algorithm in the classification of detected object into object types and families;
training an algorithm based on the input training data and the output training data;
providing the resulting trained algorithm.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented.

FIG. 2 illustrates a flowchart describing a preferred embodiment of a method for automatically creating a CAD model from a point cloud according to the invention.

FIG. 3 schematically illustrates a point cloud according to the invention.

### DETAILED DESCRIPTION

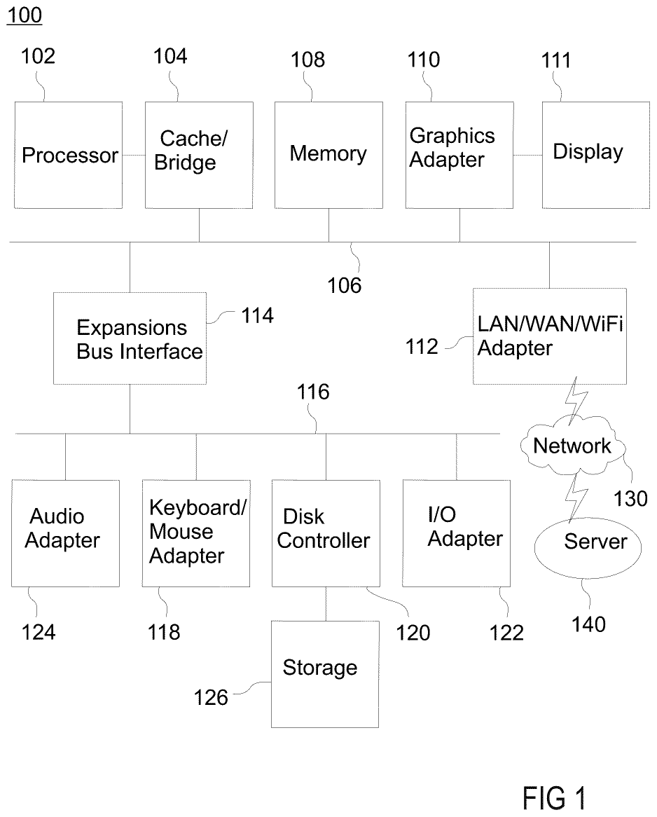

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Current techniques for creating a CAD model from a point cloud are not accurate enough and/or require a user input and/or require a CAD model library, notably when generating a CAD model from a point cloud of a scene comprising objects belonging to different object families, e.g. a robot, a fence, electronic circuit, etc. The present invention proposes indeed an efficient method and system, e.g. a data processing system, for overcoming these drawbacks. Indeed, the solution proposed by the present invention is capable of automatically generating, from a point cloud representing such a scene comprising several objects, wherein at least two objects belong each to a different object family, a very accurate CAD model for any of said two objects, for instance for both, by enabling to apply, to the concerned object, a meshing technique and/or a set of meshing parameters specifically adapted to the concerned object in order to convert points representing the concerned object into 3D surfaces of the CAD model. The present invention enables to automatically create an accurate CAD model of a complex scene comprising multiple objects belonging to different object families by making it possible to create for any of the multiple objects of said scene, a very accurate CAD model of the concerned object. As explained in more details below, this is made possible by associating to each object detected in a scene an object type, by then classifying said object type into an object family for which a meshing profile has been predefined, and using said meshing profile for converting the object points into a CAD model.

FIG. 1 illustrates a block diagram of a data processing system 100 in which an embodiment can be implemented, for example as a PDM system particularly configured by software or otherwise to perform the processes as described herein, and in particular as each one of a plurality of interconnected and communicating systems as described herein. The data processing system 100 illustrated can include a processor 102 connected to a level two cache/bridge 104, which is connected in turn to a local system bus 106. Local system bus 106 may be, for example, a peripheral component interconnect (PCI) architecture bus. Also connected to local system bus in the illustrated example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but are not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware illustrated in FIG. 1 may vary for particular implementations. For example, other peripheral devices, such as an optical disk drive and the like, also may be used in addition or in place of the hardware illustrated. The illustrated example is provided for the purpose of explanation only and is not meant to imply architectural limitations with respect to the present disclosure.

A data processing system in accordance with an embodiment of the present disclosure can include an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

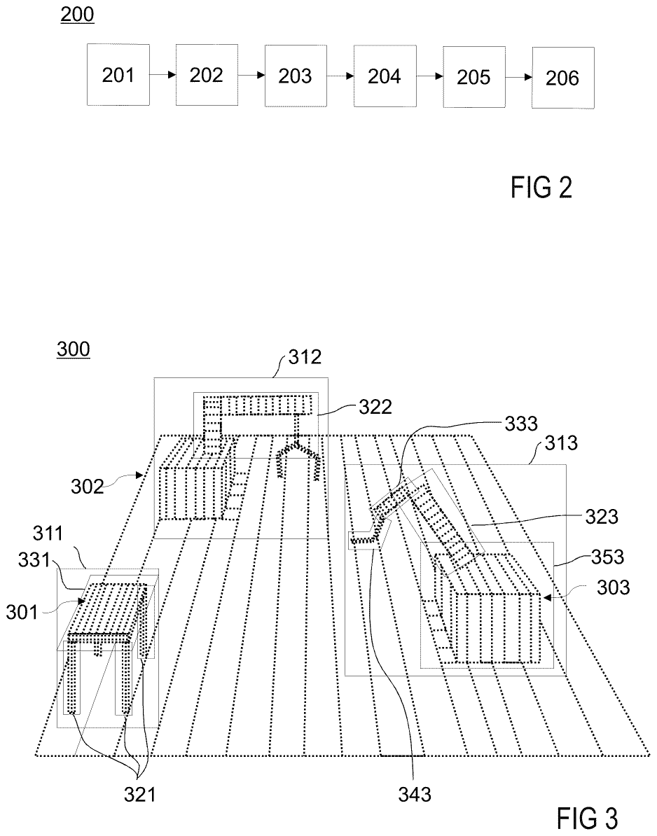

FIG. 2 illustrates a flowchart of a method for creating a CAD model from a point cloud according to the invention. The method will be explained in details hereafter in connection with FIG. 3 which presents a schematic and non-limiting illustration of a point cloud 300 acquired for instance by a point cloud scanner, notably a 3D scanner, from a scene comprising several objects. As known in the art, the point cloud scanner is configured for scanning the scene, which is a real scene, e.g. a production line of a manufacture, and collecting, from said scanning, point cloud data, i.e. one or several sets of data points in space, wherein each point position is characterized by a set of position coordinates, and each point might further be characterized by a color. Said points represent the external surface of objects of the scene, and the scanner records thus within said point cloud data information about the position within said space of a multitude of points belonging to the external surfaces of objects surrounding the scanner, and can therefore reconstruct, from said point cloud data, 2D or 3D images of its surrounding environment, i.e. of said scene, for which the points have been collected. Of course, the present invention is not limited to this specific type of scanner, and might receive or acquire point cloud data from any other kind of scanner configured for outputting such point cloud data.

The present invention is particularly advantageous for creating a CAD model of a scene, or of one or several objects of said scene, wherein the latter comprises at least two objects belonging each to a different object family. According to the present invention, each object family comprises one or several types of objects which share similar or identical external shape and/or features and/or configuration, so that a same meshing profile can be used for converting, by means of a point cloud meshing algorithm, point clouds representing objects belonging to object types of a same family into CAD models. For instance, the point cloud shown in FIG. 3 comprises a table 301, a first robot 302, and a second robot 303. The table 301 might be part of a first family, called for instance “furniture” family, which comprises different types of tables (e.g. round table, square table), different types of chairs, etc., for which a same meshing profile can be used by the meshing algorithm. The robots 302 and 303 might belong to a same family, called for instance “robot” family, which comprises different types of robots for which another meshing profile is defined, and will be automatically applied according to the present invention. Of course, it is possible to have a family for 3D motion robots, and another family for 2D motion or planar motion robots, etc., each family being then associated to a profile that defines the meshing technique to be applied to object types belonging to said family. In particular, the meshing profile is configured for defining for each bbox of the list of bboxes defined for a detected object, one or several meshing parameters that has or have to be used by the point cloud meshing algorithm for meshing the set of points associated to the concerned bbox. This enables to have, for each part of a detected object, the most adapted meshing technique used for converting the points representing said part into a CAD model of said part. Typically, if a robot comprises cables extending from a first cylindrical arm segment to a second cylindrical arm segment, the present invention proposes to use a profile that defines meshing parameters for converting the points representing said cables into a 3D CAD model of said cable that are different from the meshing parameters that will be used for converting the points representing said first and second cylindrical arm segments into their 3D CAD representation.

At step 201, the system according to the invention acquires or receives, for instance via a first interface, a point cloud 300 representing a scene comprising one or several objects, e.g. the table 301, the first robot 302, and the second robot 303, wherein preferentially at least two objects belong each to a different object family. As known in the art, said points of the point cloud define the external surfaces of the objects of said scene, and thus the (external) shape of the objects. By acquiring or receiving a point cloud, it has to be understood that the system acquires or receives point cloud data. Said point cloud data can be received from a point cloud scanner, and/or from a database, and/or provided by an operator, etc. The point cloud data comprise a set of data points in a space, as known in the art when referring to point cloud technology. From said point cloud data, it is possible to reconstruct an image, e.g. a 2D or 3D image of the scene, notably using meshing techniques that enable to create object external surfaces from the points of the point cloud. FIG. 3 simply shows the points of the point cloud 300 in a Cartesian space. In other words, the points of the point cloud data can be represented in a Cartesian coordinate system or in any other adequate coordinate system. Optionally and additionally, the system according to the invention may acquire or receive one or several images (e.g. coplanar set of pixels) of said scene, wherein each image is preferentially created from said point cloud or point cloud data, for instance from said scanner that has been used for collecting the cloud of points by scanning said scene. Said images can be 2D or 3D representations of the scene.

At step 202, the system uses a SA for detecting, in said point cloud, at least one of said one or several objects of the scene. The SA is configured for outputting, for each detected object, an object type and a bbox list comprising one or several bbox, each bbox describing notably the spatial location, within said point cloud, of a set of points that represent (i.e. belong to the representation of) said detected object or a part of the latter. In order to enable the SA to detect objects of the scene, a training process took place. Indeed, the SA according to the invention is a trained algorithm, i.e. a machine learning (ML) algorithm, configured for receiving, as input, said point cloud and optionally said one or several images of the scene, and then for automatically detecting one or several objects in the received point cloud, using optionally said images as input, notably information comprised in said images, like RGB information, for improving the detection of said objects, and for outputting, for each object detected, said object type and the list of bboxes. Advantageously, thanks to the reduced noise of said images compared to the point cloud noise, using said images together with the point cloud as input to the SA improves the object detection by the SA. In particular, the SA might be configured for matching a received 2D or 3D image of the scene with the point cloud of said scene for acquiring additional or more precise information regarding the objects of said scene: typically, image information (e.g. color, surface information, etc.) that might be found at positions in said scene that correspond to positions of points of the point cloud might be used by the SA for determining whether a specific point belongs or not to a detected object or object part.

According to the present invention, the SA has been trained for identifying, within the point cloud, sets of points whose spatial distribution and/or configuration, notably with respect to another set of points of said point cloud, matches the spatial distribution and/or configuration of sets of points representing objects of a scene that has been used for its training. By “matching” it has to be understood for instance “same or similar proportions”, “same or similar geometric configuration” (e.g. geometric orientation of a set of points with respect to another set of points which represent each a part of a same object), “same or similar shape”, etc. Each set of points identified by the SA represents thus an object or a part of an object that the SA has been able to identify or recognize within the point cloud thanks to its training. The points of a set of points are usually spatially contiguous. The SA is thus trained to identify or detect in said point cloud different sets of points that define volumes (in the sense of “shape”) that correspond, i.e. resemble, to volumes of object types it has been trained to detect and/or that show with one another (i.e. when combining one volume with one or several other volumes) a similar or same spatial “distribution and/or configuration and/or proportion” with respect to a spatial “distribution and/or configuration and/or proportion” of volumes corresponding to different parts of an object it has been trained to detect/identify. For instance, the SA might have been trained to identify in point cloud data different types of robots and is able to recognize the different parts of the robot body. The training of the SA enables thus the latter to efficiently identify some “predefined” spatial distributions and/or configurations of points within a point cloud and to assign to each set of points characterized by one of said “predefined” spatial distributions and/or configurations at least one type of object. The obtained different sets of points (or volumes), and notably how they combine together, enable the SA to detect more complex objects, like a robot, that result from a combination of said different volumes (i.e. of different sets of points). In other words, it enables the SA to distinguish a first object type, e.g. “robot”, corresponding to a first combination (i.e. spatial distribution and/or configuration) of sets of points from a second object type, e.g. “table”, corresponding to a second combination of sets of points, wherein each combination is preferably a function of the spatial distribution/configuration of the sets of points. Thus, the SA might combine several of said identified sets of points for determining the type of object, the bbox list being then configured for listing the bboxes whose associated set of points is part of said combination. Indeed, and preferably, the SA is configured for determining said type of object from the spatial configuration and interrelation of intersecting or overlapping (when considering the volume represented by each set) sets of points. For instance, a first volume or set of points might correspond to a rod (the rod might belong to the types “table leg”, “robot arm”, etc.), a second volume intersecting/overlapping with the first volume might correspond to a clamp (the clamp might belong to the types “robot”, “tools”, etc.), and a third volume intersecting/overlapping with the first volume might correspond to an actuator configured for moving the rod (the actuator might belong to the type “robot”, etc.), and due to the interrelation (respective orientation, size, etc.) and/or spatial configuration and/or spatial distribution of the 3 volumes, the SA is able to determine that the 3 volumes (i.e. sets of points) belong to an object of type “robot”. Furthermore, the SA is preferentially configured for defining for, or assigning to, each set of points that has been identified, said bbox. The bbox defines an area or a volume within the point cloud that comprises the set of points it is assigned to. It is preferentially a segmented volume, i.e. a 3D volumetric representation of the object or one of its parts, comprising information about the spatial location, orientation, and size of said object or part. For instance, an arm of a robot can be represented by 3 cylindrical shapes that have a specific orientation, location, and size with respect to each other, each of said cylindrical shapes being a bbox according to the invention. The bbox associated to an object, or resp. to a part of the latter, is thus characterized by geometrical characteristics that are directly related to the geometrical characteristics of said (real) object of the scene, or resp. part of the latter. There is no limitation regarding the shape of the bbox, but simple 3D volumes or shapes, like cylinder, sphere, prism, are preferred. The SA is thus configured for mapping each identified set of points to a bbox. Examples of bboxes are illustrated in FIG. 3 by rectangles with the references 321, 331, 343, 333, 353, 323, but they might have any other shapes that are convenient for highlighting on a display a specific object or part of object. In particular, known in the art machine learning algorithms might be used for detecting said objects in said images for helping the SA to determine sets of points corresponding to objects or object parts. At the end, as explained previously, the SA is configured for outputting, for each detected object, a type of the object and a bbox list.

According to the present invention, the type of the object belongs to a set of one or several predefined types of objects that the SA has been trained to detect or identify. For instance, referring back to FIG. 3, one type or class of object can be “robot”, wherein the first robot 302 and the second robot 303 belong to the same object type. The SA might also be configured to identify different types of robots. According to FIG. 3, another type or category of object could be “table”. Based on FIG. 3, only object 301 is detected as belonging to the type “table”. The SA can detect or identify a whole object and/or object parts. For instance, it is preferentially configured for detecting object parts or elements, like the sets of points corresponding to each table leg 321, another set of points for the table top 331, other sets of points for the robot arms 323, 333 and for the robot clamp 343, etc. It is thus configured, i.e. trained, for identifying in a point cloud received as input, one or several sets of points corresponding to whole object or object parts it has been trained to identify or recognize. The SA is typically configured for classifying each detected object (or object part), i.e. identified set of points, in one of said predefined types. In particular, a plurality of objects or object parts characterized by different shapes, edges, size, orientations, etc., might belong to a same object type. For instance, a round table, a coffee table, a rectangular table, etc., will all be classified in the same object class or type “table”. Then, since an object, e.g. a robot, might comprise different parts, e.g. a clamp, an arm, etc., then a type of object, e.g. the type “robot”, might be defined as a combinations of several objects (sub)types that have been trained to be detected or identified by the SA. For instance, “table leg” and “tabletop” might be two (sub)types of objects that, when combined together, result in the object type “table”. The same applies for “robot arm”, which is a “sub-type” of the object type “robot”. The SA might be configured for using a hierarchical representation of each object, wherein the “main” (i.e. whole) object belongs to a “main” type of object, and parts of said main object belong to sub-types of objects. Said hierarchy may comprise several levels. By this way, the SA may identify or detect in the point cloud a plurality of object types that represent simple shapes or volumes that are easily identifiable, and in function of the combination of the latter (i.e. in function of their spatial relation, configuration, distribution), it can determine the type of more complex objects, i.e. the type of said main object.

The bbox according to the invention is preferentially a 3D volume configured for surrounding all points of said point cloud that are part of an identified set of points. FIG. 3 shows for instance bboxes 312, 322, 313, 323, 333, 343, 353 that have been determined by the SA according to the invention. While shown as 2D rectangles, said bboxes have preferentially the same dimensions as the objects they surround, i.e. they will be 3D bboxes if the detected object is a 3D object. For the example of FIG. 3, the SA is capable of distinguishing two different types of objects, namely the type “table” and the type “robot”. For instance, the SA is configured for identifying the set of points comprised within the bboxes 353, 323, 333, and 343, to assign to each identified set of points a bbox, and to determine from the spatial distribution and/or configuration and/or interrelation (notably whether they define intersecting/overlapping volumes, and/or from the relative size of said volumes) of said sets of points that their combination represents an object of type “robot”. The same applies to the set of points comprised within the bboxes 321 (i.e. table legs), and 301 (i.e. table top): from their spatial distribution and/or configuration and/or interrelation, the SA is able to determine that they represent an object of type “table”. For each detected object, i.e. table, robot, arm, it outputs the object type and a bbox list comprising all bboxes that are related to the detected object in that they are each mapping a set of points that represents the detected object or a part of the latter. The object 301 is thus associated to the type “table” and surrounded by the bbox 311. The different parts of object 301, like table legs, might also be surrounded by bboxes 321. The first robot 302 and the second robot 303 are each associated to the type “robot” and surrounded respectively by the bboxes 312 and 313. The arm of the first robot 302 is associated to the type “arm” and surrounded by the bbox 322. The arm of the second robot 303 is associated to the type “arm” and surrounded by the bbox 323. If another robot arm would be placed on the table 301, then the SA would associate it to the type “arm” and surround it with another bbox. Each bbox provides information about the location of the object with respect to a coordinate system used for representing the point cloud. At the end, the SA outputs thus for each detected object a set of data comprising the object type and a bbox list, i.e. information about the object type and information about its size and position within the point cloud as provided by the bboxes of the list.

At step 203, which can take place simultaneously, after or before step 201 and/or 202, the system is configured for defining or creating or receiving or acquiring one or several object families. For instance, object families might be defined or stored in a database, e.g. by a user, and the system according to the invention is configured for automatically acquiring or receiving said object families. According to the present invention, each object family is configured for defining or creating or storing or comprising a profile defined for one or several point cloud meshing algorithms. The point cloud meshing algorithm according to the invention is typically a known in the art meshing algorithm. The profile according to the invention is configured for specifying a meshing technique, e.g. meshing parameters, that has to be used by the point cloud meshing algorithm when converting to a 3D surface a point cloud representing an object whose type belongs to the object family for which said profile has been defined. In particular, said profile defines for each bbox, the meshing technique, e.g. meshing parameters and/or meshing algorithm, that has or have to be used for converting the set of points associated to said bbox into 3D surfaces. In other words, the meshing profile defines for instance, for each bbox of the list of bboxes associated to a detected object, the meshing algorithm and the meshing parameters that have to be used by said meshing algorithm. Said meshing parameters are notably configured for controlling how the points of the concerned set of points are connected with each other for creating discrete and geometric cells that constitute said 3D surface of the CAD model. In particular, a single profile is defined for each object family. This means that a different meshing technique, e.g. different meshing parameters and/or meshing algorithm, will be used in function of the object family to which a detected object belongs to. According to the present invention, each family may further comprise or be associated to one or several of said predefined object types so that each predefined object type be assigned to a single family, and each family is assigned to a different profile. Basically, each family is configured for grouping together objects, or more precisely types of objects, that require the same meshing profile, for instance the same meshing parameters, for converting points into 3D surfaces of a CAD model. For instance, a first family can comprise a profile defined for articulated robots, a second family can comprise another profile defined for Cartesian robots, another family can comprise yet another profile defined for electronic card, etc. Preferentially, the system according to the invention comprises a database storing one or several object families, e.g. a “robot” family, and/or a “furniture” family, and/or a “conveyor” family, and/or a “fence” family, and/or a “floor, ceiling, and wall” family, and/or a “PLC box” family, and/or a “stair” family, and/or a “pillar” family, etc. Each family comprises a profile, wherein said profile defines, for each bbox of an object whose type belong to said family, one or several meshing parameters and/or one or several meshing algorithms, with preferentially, for each meshing algorithm, a set of one or several of said meshing parameters, that have to be used, for converting the set of points associated to said bbox into a 3D surface, i.e. for creating, from said points, a set of geometrical and topological cells which together form said 3D surface modelling the object or object part associated to said bbox.

Each profile being different, the system according to the invention will be able to apply within the same scene, i.e. within the point cloud representing said scene, different meshing techniques (e.g. meshing parameters and/or meshing algorithms) in function of the membership of the detected objects to the families defined by or in the system, e.g. in said database. Thanks to this feature, the most adapted meshing technique for converting points of an object into 3D surfaces of a CAD model will be applied by the system to each object, or a selection of objects, detected in a scene and for which an object type and object family has been assigned by said system.

Indeed, at step 204, the system is configured for automatically determining, for each object detected, the family to which the object type of the detected object belongs to. Preferentially, the SA is additionally trained for automatically classifying each object type in an object family, taking for instance into consideration the typical external shape of objects belonging to said object type: for instance, if two object types are characterized by a typical external shape that share common or similar geometries of their external surfaces, then they will be classified into the same family. Alternatively, a database may associate each of said predefined object types to a single family, listing for instance for each object family the predefined object types belonging to the latter. In particular, according to the present invention, each object type belongs to a single family, and each family defines a unique meshing profile for converting the different parts of an object whose type belongs to said family into a 3D meshed surface, and thus the object into a 3D CAD model, the meshing profile defined for each family being different.

At step 205, the system automatically creates a CAD model by running the point cloud meshing algorithm on the set(s) of points assigned or associated to the bbox(es) of the bbox list outputted for the detected object, wherein said running comprises using the meshing technique defined by the profile assigned to the family to which the object type of the detected object belongs to for converting said set(s) of points to 3D surface(s) of the CAD model. In other words, if the scene comprises several objects, wherein the associated object types outputted by the SA for said objects are classified in different object families, then the system according to the invention will automatically change the meshing technique used for converting the points representing said objects into 3D surfaces of the CAD model in function of the family to which said objects belong to. The meshing technique used for the different objects being adapted to the latter, the resulting CAD model of each object, and for instance and consequently of the scene, is improved and more accurate.

At step 206, the system automatically provides the CAD model via an interface. In particular, the system might be configured for automatically storing the created CAD model, e.g. the CAD model outputted for one or each detected object. Preferentially, the system is configured for automatically replacing the set(s) of points assigned or associated to the bbox(es) of the bbox list outputted for the detected object by the created CAD model. At the end, the system may automatically display the or each created CAD model, for instance said scene wherein one or several or all detected objects have been replaced by their respective CAD model.

Advantageously, for a same point cloud received as input and comprising at least two sets of points, each representing an object of a scene, wherein at least one of said objects requires a different meshing technique compared to the other, the present invention enables to automatically select and apply, for at least one of said objects, preferentially each of said objects, a meshing technique that is specifically adapted for converting the concerned points into 3D surfaces of a resulting CAD model by determining to which type of object the concerned object belongs to, to which family said object type belongs to, deducing thus from the profile stored for said family the meshing technique to be applied. This enables to produce a CAD model of a scene comprising multiple types of objects that is very accurate compared to existing techniques, because the meshing parameters and/or meshing algorithms that will be used is different for each object.

Advantageously, the generated CAD model might be used for populating a CAD library. The latter can then be used for planning, and/or validating, and/or generating 3D CAD scenes that later can be augmented with various information. The obtained 3D CAD model might also be used for simulation and/or verification, e.g. the simulation of a production line, and then for instance its construction based on said simulation. Indeed and for instance, the outputted CAD model can be used as input to a device in charge of optimizing and/or building and/or modifying one or several of the objects of said scene, said device receiving, thanks to the present invention, a very accurate and correct information regarding each object and its surrounding environment. Compared to existing techniques, this accuracy and correctness of the received information might enable said device to improve the calculation and/or determination of a motion of one of said objects, and/or to determine an optimized design, and/or to determine motion control command(s) of said object(s), notably in function of the surrounding environment of the concerned objects. This might decrease for instance the risk of collision of an object part, e.g. a robot arm, with its surrounding environment, e.g. another object arm. The present invention is thus a great tool for helping building and/or modifying of a production line, or more generally, objects of the scene.

In embodiments, the term “receiving”, as used herein, can include retrieving from storage, receiving from another device or process, receiving via an interaction with a user or otherwise.

Those skilled in the art will recognize that, for simplicity and clarity, the full structure and operation of all data processing systems suitable for use with the present disclosure is not being illustrated or described herein. Instead, only so much of a data processing system as is unique to the present disclosure or necessary for an understanding of the present disclosure is illustrated and described. The remainder of the construction and operation of data processing system 100 may conform to any of the various current implementations and practices known in the art.

It is important to note that while the disclosure includes a description in the context of a fully functional system, those skilled in the art will appreciate that at least portions of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims.

1-15. (canceled)

16. A method for creating a computer-aided design (CAD) model from a point cloud representing a scene having one or several objects, the method comprises the steps of:
acquiring or receiving the point cloud representing the scene having the one or several objects;
using a segmentation algorithm (hereafter “SA”) configured for receiving as an input the point cloud, for detecting at least one of the one or several objects in the point cloud, and for outputting, for each object detected in the point cloud, an object type and a list of bounding boxes, wherein the object type is chosen among a set of one or several predefined object types that the SA has been trained to identify, wherein each bounding box of the list of bounding boxes defines a spatial location within the point cloud containing a set of points representing a detected object or a part of the detected object;
receiving or acquiring one or several object families, wherein each object family contains a profile defined for a point cloud meshing algorithm, wherein the profile is configured for specifying a meshing technique to be used by the point cloud meshing algorithm when converting the point cloud representing the object belonging to the object family to a 3D surface, wherein each said object family contains one or several of the predefined object types so that each predefined object type be assigned to a single object family, and wherein each said object family is assigned to a different profile;
for each said detected object, determining the object family to which its said object type belongs to, and then automatically creating the CAD model by running the point cloud meshing algorithm on the set of points assigned or associated to at least one of the bounding boxes of the list of bounding boxes, wherein the running includes using a meshing technique defined for the profile assigned to the object family to which the object type of the detected object belongs to for converting the set of points to the 3D surface of the CAD model; and
automatically providing the CAD model created via an interface.

17. The method according to claim 16, which further comprises automatically storing the CAD model created and/or using the CAD model for simulating and/or optimizing and/or building the object represented by the CAD model.

18. The method according to claim 16, which further comprises replacing the set of points assigned or associated to at least one of the bounding boxes of the list of bounding boxes by the CAD model.

19. The method according to claim 16, wherein the object families and associated profiles are stored in a database and contain at least a robot family, and/or a furniture family, and/or a conveyor family, and/or a fence family, and/or a floor, ceiling, and wall family, and/or a PLC box family, and/or a stair family, and/or a pillar family, wherein each of the object families contains a meshing profile, wherein the meshing profile is configured for defining, for each said bounding box of the list of bounding boxes associated to said object whose type belongs to the object family, one or several meshing algorithms, and for each meshing algorithm, one or several meshing parameters that have to be used for converting the set of points associated to the bounding box to the 3D surface.

20. The method according to claim 16, wherein the SA is a trained algorithm configured for receiving, as an input, the point cloud, and for automatically detecting or identifying one or several sets of points within the point cloud matching a spatial configuration and/or distribution of objects or part of the objects that it has been trained to detect, wherein each of the objects or the part of the objects it has been trained to detect belongs and is assigned to one of the predefined object types, for mapping each of the sets of points to said bounding box, and for outputting, for each said detected object, the type of object it represents and the list of the bounding boxes.

21. The method according to claim 20, wherein the SA is configured or trained for combining several of identified sets of points for determining the type of object, the list of bounding boxes being configured for the list of bounding boxes whose associated set of points is part of a combination.

22. The method according to claim 16, which comprises acquiring or receiving one or several images of the scene, and using said one or several images together with the point cloud as an input to the SA for detecting said one or several objects.

23. A method for providing, by a data processing system, a trained algorithm for detecting at least one object in a point cloud representing a scene and assigning, to each detected object, an object type chosen among a set of one or several predefined types and a list of bounding boxes, the method comprises the steps of:
receiving input training data, wherein the input training data contains a plurality of point clouds, each representing a scene, each said scene having one or several objects;
receiving output training data, wherein the output training data identifies, for each of the point clouds of the input training data, at least one object of the scene, and for each identified said object, associates to said object the object type chosen among the set of said one or several predefined types and the list of bounding boxes, wherein each bounding box of the list of bounding boxes defines a spatial location within a point cloud containing a set of points representing the object or a part of the object;
training an algorithm based on the input training data and the output training data; and
providing the trained algorithm.

24. The method according to claim 23, wherein the trained algorithm is further configured for classifying each said detected object into an object family in dependence on the object type associated to the detected object.

25. A data processing system, comprising:
a processor; and
an accessible memory, the data processing system configured to:
acquire or receive a point cloud representing a scene having one or several objects;
use a segmentation algorithm (hereafter “SA”) configured for receiving as an input said point cloud, for detecting at least one of said one or several objects in said point cloud, and for outputting, for each detected object in the point cloud, an object type selected among a set of one or several predefined object types and a list of bounding boxes, wherein each bounding box of said list is configured for defining a spatial location within said point cloud having a set of points representing the detected object or a part of the detected object;
define one or several object families, and for each of said object families, to define or create or store a profile defined for a point cloud meshing algorithm, wherein said profile is configured for specifying a meshing technique to be used by said point cloud meshing algorithm when converting said point cloud representing the object belonging to an object family to a 3D surface, wherein each of said object families contains one or several of said predefined object types so that each predefined object type be assigned to a single said object family, and wherein each of said object families is assigned to a different profile;
for each said detected object, determine the object family to which its said object type belongs to, and then automatically create a computer-aided design (CAD) model by running said point cloud meshing algorithm on the set of points assigned or associated to the bounding box of said list of bounding boxes, wherein said running includes using the meshing technique defined for the profile assigned to the object family to which the object type of the detected object belongs to for converting said set of points to a 3D surface of the CAD model; and
automatically provide a created said CAD model via an interface.

26. The data processing system according to claim 25, wherein the data processing system is configured to replace said set of points assigned or associated to the bounding box of said list of bounding boxes by the CAD model.

27. The data processing system according to claim 25, further comprising a database, wherein the object families and associated profiles are stored in said database and contain at least a robot family, and/or a furniture family, and/or a conveyor family, and/or a fence family, and/or a floor, ceiling, and wall family, and/or a PLC box family, and/or a stair family, and/or a pillar family, wherein each said object family contains a meshing profile, wherein said meshing profile is configured for defining, for each said bounding box of the list of bounding boxes associated to said object whose said object type belong to said object family, one or several meshing parameters and/or one or several meshing algorithms that have to be used for converting the set of points associated to said bounding box to the 3D surface.

28. A non-transitory computer-readable medium encoded with executable instructions that, when executed, cause one or more data processing system to:
acquire or receive a point cloud representing a scene containing one or several objects;
use a segmentation algorithm (hereafter “SA”) configured for receiving as an input said point cloud, for detecting at least one of said one or several objects in said point cloud, and for outputting, for each detected object in said point cloud, an object type selected among a set of one or several predefined object types and a list of bounding boxes, wherein each bounding box of said list of bounding boxes is configured for defining a spatial location within said point cloud containing a set of points representing the detected object or a part of the detected object;
define one or several object families, and for each object family, to define or create or store a profile defined for a point cloud meshing algorithm, wherein said profile is configured for specifying a meshing technique to be used by said point cloud meshing algorithm when converting the point cloud representing the object belonging to said object family to a 3D surface, wherein each said object family contains one or several of said predefined object types so that each predefined object type be assigned to a single said object family, and wherein each said object family is assigned to a different profile;
for each said detected object, determine the object family to which its said object type belongs to, and then automatically create a computer-aided design (CAD) model by running the point cloud meshing algorithm on the set of points assigned or associated to the bounding box of said list of bounding boxes, wherein said running includes using the meshing technique defined for the profile assigned to the object family to which the object type of the detected object belongs to for converting said set of points to said 3D surface of the CAD model; and
automatically provide a created said CAD model via an interface.

29. The non-transitory computer-readable medium according to claim 28, wherein the non-transitory computer-readable medium is configured to automatically replace said set of points assigned or associated to the bounding box of said list of bounding boxes by said CAD model.

30. The non-transitory computer-readable medium according to claim 28, wherein the object families and associated profiles contain at least a robot family, and/or a furniture family, and/or a conveyor family, and/or a fence family, and/or a floor, ceiling, and wall family, and/or a PLC box family, and/or a stair family, and/or a pillar family, wherein each said object family contains a meshing profile, wherein said meshing profile is configured for defining, for each said bounding box of the list of bounding boxes associated to said object whose said object type belongs to said object family, one or several meshing parameters and/or one or several meshing algorithms that have to be used for converting the set of points associated to said bounding box to said 3D surface.
